(19) United States
(12) Patent Application Publication
(10) Pub. No.: US 2001/0029989 A1
(43) Pub. Date: Oct. 18, 2001

(54) Pipeline identification and positioning system

(76) Inventor: German N. Paz, Sugarland, TX (US)

Correspondence Address: Al Harrison, Harrison & Egbert, 1018 Preston #100, Houston, TX, 77002, US

(21) Appl. No.: 09/781,611

(22) Filed: Feb. 12, 2001

Related U.S. Application Data
(60) Provisional application No. 60/183,290, filed on Feb. 17, 2000.

(51) Int. Cl. F16L 55/00

(52) U.S. Cl. 138/104; 138/155; 138/178

(57) ABSTRACT

A system for identifying and positioning pipelines that accurately and unequivocally marks a section of pipeline and tubular goods located anywhere for subsequent identification. The pipeline positioning system comprises a permanent, passive, non-obtrusive, and systematic placement of marker coupons upon pipe diameters for uniquely identifying a pipeline or specific location therein. Identification and location codes incorporated into the markers may be readily detected by inspection methods known in the art. Codes may be applied to new tubes or pipelines during manufacturing, during pipeline laying operations, or during maintenance being rendered by the pipeline owner or operator.

### RELATED APPLICATIONS

This application claims priority based upon provisional application Ser. No. 60/183,290 filed Feb. 17, 2000.

### BACKGROUND OF THE INVENTION

Gas and petroleum products are transported on a worldwide basis by routinely passing through systems of pipelines constructed of different sizes and lengths. It is well known in the art that a substantial investment of time and money is associated with establishing and maintaining a pipeline system of such global extent. It is also well known in the art that the implicated plurality of pipelines is normally protected by certain features that are intended to prevent damage and corrosion. While most pipeline systems are designed to operate continuously for several years without interruption, a plethora of factors actually determine the life expectancy thereof.

As is well known in the art, Smart Pigs are electronic instruments designed to inspect pipelines internally while physically traveling with a fluid product within the pipelines, and without simultaneously interrupting fluid flow. That is, Smart Pigs are inspection devices that travel inside a pipeline and are pushed therealong by the fluid flowing therein. Having been used since the mid-1960's, Smart Pigs primarily detected wall-thinning attributable to corrosion and the like. As will be appreciated by those skilled in the art, various other pipeline defects including dents, gouges, cracks, and coating disbandment have eluded detection via Smart Pigs for several years. Due to pipelines being situated either on, in, or under a diversity of terrains and the like throughout the world, there is a strong demand for Smart Pigs that are capable of traveling within multi-diameter pipelines and concomitant bends therein, and of detecting the location of pipe-related problems.

Depending on the technology and degree of sophistication used by a Smart Pig, its sensors will record the distance traveled, location and clock position of features and defects, and the concomitant depth and magnitude thereof. As will be understood by those skilled in the art, inspection companies use several technologies to detect defects in a pipeline including Magnetic Flux Leakage (MFL), ultrasound, radiography, acoustic emission, etc.

MFL, of course, uses magnets to detect corrosion on thinning pipeline walls. Ultrasonic sensors are used to detect dents, gouges, cracks, and coating disbondment. The Global Positioning System (GPS) has been adapted to work with Smart Pigs to ascertain the exact location of any problem manifest within pipelines or, indeed, to map the pipeline, per se. It will be appreciated by those skilled in the art that some Smart Pigs are constructed with a collapsible design that readily accommodates entry into multi-diameter pipelines that include gate valves and the like.

An alternative to this MFL approach is the use of Smart Pigs incorporating ultrasonic technology to determine pipeline wall thickness as a means of monitoring the incidence of corrosion and the like. According to this methodology, a Smart Pig provides data prerequisite for analyzing the pipeline surface throughout its length for traces of corrosion. Besides not adversely affecting normal fluid flow operations throughout the pipeline, ultrasonic detection enables identification of the extent, location, depth, and position of any corrosion.

As is known by those skilled in the art, special Crawler Pigs have been recently introduced to self-propel themselves through a pipeline under conditions in which there is insufficient fluid flow therein. Another variety of pig monitors pipeline wall deformations using differential GPS surveying devices, whereby cracks, dents, buckles, and bending strain may be accurately measured. An interesting aspect of this GPS approach is that such factors as slope instability, subsidence, overburden, river crossings, free spanning, and temperature and pressure changes may be ascertained.

Smart pigs record pipeline attachments on a continuous graph or log. These locations are also marked with posts above-ground. A geographical correlation between the buried pipe logged by the pig and the above-ground benchmark is necessary. Defects are located by excavating the pipeline with measurements recorded by the pig between the defect and the nearest benchmark. Unfortunately, most pipelines do not have enough features to help correlate a buried section of pipe to a visible benchmark above-ground. Excavating a pipeline to locate a defect is a very expensive process.

Inspection companies have developed different methods of placing references at closer intervals to reduce the distance traveled from a pipeline benchmark to a defect. Pipeline markers are either placed directly on the pipe or emit electronic signals above-ground. For markers placed on the pipe, it is necessary to excavate the pipeline, forming a bell-hole. A worker then removes the protective coating and attaches the marker or magnet to the pipe. Markers that emit electronic signals are placed above-ground, directly above the pipeline, in the smart pig's path. Signals are processed and correlated to the pig's internal odometer to obtain above-ground distances to specific locations. Both these types of pipeline markers require that their location be identified before the markers are removed. Stakes or posts are currently used to identify the location.

Radial orientation of defects is achieved by viewing the circumference of the pipe as a clock face while looking towards the end of the pipeline. The depth of the defect is detected with smart sensors that detect changes in the thickness of the pipeline wall.

Many factors contribute to costly errors in pipeline inspection with smart pigs. Faulty correlation of distances jeopardizes the effectiveness of the inspection service and creates hazardous conditions for the public at large. A pipeline positioning system contemplated by the present invention would eliminate or reduce the plethora of problems that have plagued those skilled in the art for years. For instance, while smart pigs travel the buried pipeline, such pipelines do not necessarily follow the profile of the terrain above-ground. As another example, pipeline operators may monitor operational parameters, but cannot micro-manage and control product speed, pressure, and other parameters required by smart pigs throughout the inspection run. Electronic pipeline markers are inherently prone to suffer from interference by stray radio or electronic signals. Excavations are costly and have to be scheduled in advance.

Similarly, while the Global Positioning System (GPS) helps to record accurate references above-ground, it fails to record both pig position and pipeline location at the same time. Pipeline owners currently assume all liabilities pertaining to the use of markers and also pay for the transportation to and from job sites for every inspection with smart pigs. Inspection companies use a variety of inspection methods that are frequently unknown to pipeline operators. Operators cannot routinely acquire understanding and knowledge of each such inspection methodology. Furthermore, retraining of crews is often necessary for the prerequisite inspection to occur. Pipeline owners are, of course, billed for installation, transportation, and loss or theft of every magnet or electronic unit used during pipeline inspections. Moreover, typical inspection logistics dictate that magnets be shipped in sufficient numbers or, otherwise, the operator must leap-frog the limited available magnet units during the survey.

As will be appreciated by those conversant with the art, some geographic locations are not safe for placement of inspection equipment at night particularly during a protracted inspection run. Another inherent infirmity of prior art pipeline inspections is that inspection companies assume little or no liability if the signals produced by these magnets are confused with other signals such as existing taps, patches or any metallic mass that resemble magnet signals. Still another well known problem in the art is that missing magnets leave voids that jeopardize the integrity and accuracy of the inspection. Electronic markers may not be detected by the smart pig due to: malfunction in the additional components, stray radio or electronic signals, deeper than expected pipeline, or misplacement of marker in a multiple corridor of pipelines.

Problems also arise when signals are recorded in the wrong places. There is presently no method known in the art that distinguishes the units which fail from those that do not. The excavation of defects is usually the only way these problems have been discovered. On several occasions in the field, unfortunately, this happens weeks or even months after the inspection report has been received wherein budgets have already been allocated for repairs of all pipeline defects. Pipeline maintenance is addressed as a program for all defects found by smart pigs, in a repair by repair approach. If an error is discovered it usually means several defects are being excavated in the wrong areas. Many pipelines, unfortunately, are excavated in urban areas with the consequent disruptions of neighborhoods.

Transportation of goods above-ground is normally regulated and monitored to safeguard the public. If a vehicle or practice is deemed unsafe, measures can be implemented to correct the problem. Similarly, if a specific section of pipe is found to be defective under certain operating conditions, this knowledge can be shared with other operators or regulatory agencies through the use of pipeline positioning coding contemplated under the present invention.

Accordingly, having a pipeline positioning system taught by the present invention would afford the advantage of a coding structure being emplaced in all sections of pipe and being recorded in an associated database of all pipelines. This database would preferably keep track of pipeline performance under a diversity of operating conditions. Information accumulated by pipeline owners through smart pig inspection-especially relating to noticeable deterioration or improvement of pipelines under certain conditions-could be shared expeditiously among practitioners in the art, thereby resulting in more reliable pipeline performance, increased public safety, and reduced operating costs.

Thus, there appears to be no available fail-safe and unobtrusive methodology for reliably and accurately identifying and positioning pipelines. Accordingly, these limitations and disadvantages of the prior art are overcome with the present invention, and improved means and techniques are provided that are useful for identifying and positioning pipelines regardless of physical location.

### SUMMARY OF THE INVENTION

The Pipeline Identification And Positioning System (“PIPS”) of the present invention comprises a permanent, passive, non-obtrusive, and systematic placement of markers that uniquely identify a pipeline or a specific location in a pipeline. As will be hereinafter described, PIPS assigns an identification code to locations selected by the pipeline operator that may be detected by inspection methods known in the art. As will be appreciated by those skilled in the art, PIPS enables the accurate recording of changes in pipe wall thickness via ultrasonic, radiographic, magnetic detection methods and the like.

When coupled with satellite readouts of the installation, the system taught by the present invention has been found to be accurate within centimeters of its location for any inspection run, regardless of methodology used or inspection vendor. The particular geographical areas recorded may be used by the pipeline owner, regulatory agencies, inspection companies, government security or safety agencies, etc.

These and other objects and features of the present invention will become apparent from the following detailed description, wherein reference is made to illustrative examples and to the figures in the accompanying drawings.

### BRIEF DESCRIPTION OF DRAWINGS

FIG. 1 depicts a frontal perspective view of a section of pipe showing the PIPS Registration Mark disposed on the external circumference thereof, representing the beginning of code of the preferred embodiment of the present invention.

FIG. 2A depicts a simplified end view of a section of pipe showing the PIPS Registration Mark for beginning of code depicted in FIG. 1.

FIG. 2B depicts a simplified end view of a section of pipe showing the PIPS Registration Mark for beginning of code disposed on the internal circumference of a section of pipe.

FIG. 2C depicts a simplified end view of a section of pipe showing the PIPS Registration Mark for beginning of code disposed within the wall structure of a section of pipe.

FIG. 3 depicts numeric representation of a plurality of marker coupons of PIPS of the preferred embodiment, and the registration marks for beginning and end of code markings.

FIG. 4 depicts alphabetic representation of a plurality of marker coupons of PIPS of the preferred embodiment, and the registration marks for beginning and end of code markings.

FIG. 5 depicts geographical landmark and location representation of a plurality of marker coupons of PIPS of the preferred embodiment, and the registration marks for beginning and end of code markings.

FIG. 6A depicts a sketch of a commonly used above-ground pipeline marker indicating a Mile Post 4 or MP4.

FIG. 6B depicts PIPS markings applied to the MP4 pipeline depicted in FIG. 6A.

FIG. 7A depicts a sketch of a commonly used above-ground pipeline marker indicating a Mile Post 8 or MP8.

FIG. 7B depicts PIPS markings applied to the MP8 pipeline depicted in FIG. 7A.

FIG. 8 depicts a simplified sketch of a pipeline segment having plurality of spaced-apart coupons as appropriate to property represent the PIPS code as contemplated by the present invention.

FIG. 9 depicts a data flow diagram illustrating the database of the present invention.

FIG. 10 depicts a simplified system flow diagram for remote access to the database depicted in FIG. 9.

FIG. 11 depicts a sample tabulation of pipeline information compiled into the PIPS database.

FIG. 12A depicts a simplified end view of a section of pipe showing a PIPS code implemented with marks that are disposed within the wall structure at less than 90° positions.

FIG. 12B depicts a simplified end view of a section of pipe showing the PIPS code implemented with marks that are disposed on the external circumference at less than 90° positions.

### DETAILED DESCRIPTION

The pipeline identification and positioning system (“PIPS”) of the present invention comprises a systematic application of a plurality of in situ markers that enable changes in local pipeline thickness to be identified and located. As will be hereinafter described in detail, the preferred embodiment of PIPS provides a code structure incorporated into this plurality of in situ markers that is “readable” by smart pigs or other comparable detection devices known in the art. It will be appreciated by those skilled in the art that such detection devices use a variety of technologies and concomitant resolutions for inspecting pipelines.

It will be understood that markers taught by the preferred embodiment of the present invention are designed for detection by the lowest resolution available in the art. Such a characteristic, of course, assures universal detection of pipeline irregularities or the like, independent of the particular detection device or technology used. It is an advantage and feature of PIPS of the present invention that it does not have to be upgraded to accommodate changes in detection and inspection technology. Accordingly, while any advance in the detection methodology art allows for more sophisticated codes to be provided as contemplated by the present invention, nevertheless, no changes or retrofitting in existing marker-installations will be necessary.

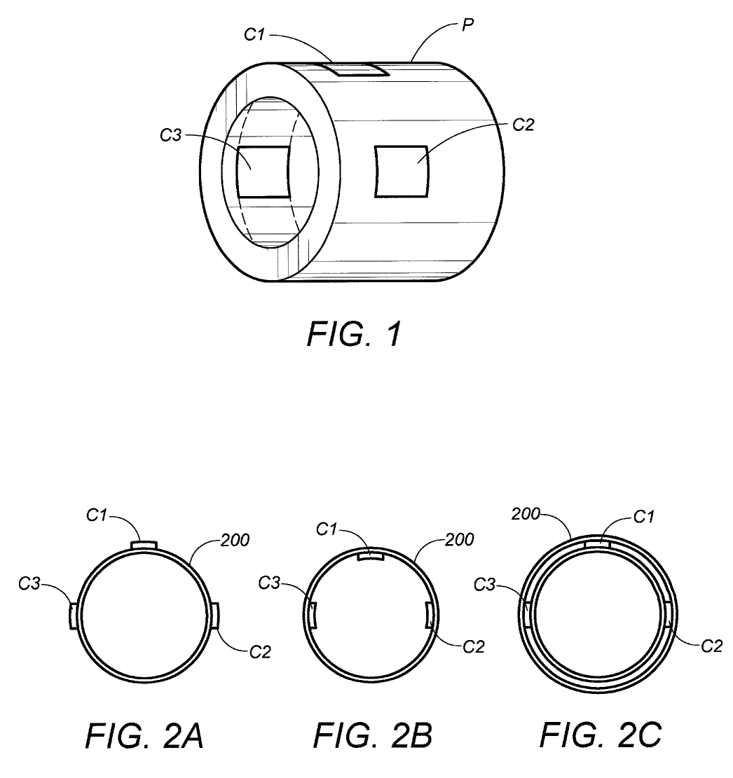

Under the present invention, marker means are disposed upon a pipe's external or internal circumferential surface as will be hereinafter described. FIG. 1 depicts a frontal perspective view of section of pipe P showing the PIPS Registration Mark comprising plurality of coupons C1, C2, and C3 emplaced upon the exterior circumference thereof, for the preferred embodiment of the present invention. As will be hereinafter described, referring to FIGS. 1 and 2 A, B, C, this predefined configuration of marks successively disposed at 90° positions, from 9 o'clock to 12 o'clock to 3 o'clock, represents the preferred beginning-of-code marker. FIG. 2A shows a simplified end view of the embodiment of the present invention wherein plurality of markers or coupons C1, C2, and C3 are disposed on the external diameter or circumference of pipe segment P. In the alternative embodiment shown in FIG. 2B, plurality of markers C1, C2, and C3 are emplaced upon the internal diameter of pipe segment P. In another embodiment shown in FIG. 2C, coupons C1, C2, and C3 are incorporated into the wall structure pipe segment P, thereby altering the local wall thickness. As will become clear to those skilled in the art, through detection by marker means coded according to the teachings of the present invention, defects and other pipeline anomalies may be identified and positioned with an accuracy, reliability, and convenience heretofore unknown in the art.

Thus, in the preferred embodiment, the external diameter disposed on a pipe segment's circumference is subdivided into four areas for coupon emplacement. Under this placement strategy, moving along the circumference in a clockwise direction, a coupon is emplaced at successive 90° positions thereof: top, right side, bottom, and left side. That is, suitably-coded marker coupons are positioned at the 12 o'clock, 3 o'clock, 6 o'clock, and 9 o'clock positions, respectively.

Referring now collectively to FIGS. 2 A-C, there is seen how the present invention uses a plurality of markers or coupons to represent the top—12 o'clock—pipe position as the zero reference point. As will become clear to those skilled in the art, this zero reference position of the pipe corresponds to a Registration Mark that conforms to the actual top position along pipeline sections. This Registration Mark has been found to constitute a reliable means for ascertaining whether a smart pig or other detection device is recording the correct orientation of a pipeline section. Plurality of coupons 200 correspond to coupon C1 disposed at the 12 o'clock position and interposed between coupons C2 and C3, respectively. Coupon C3 is seen to be disposed at the 9 o'clock position and coupon C2 is disposed at the 3 o'clock position. It will be appreciated that the Registration Mark taught by the present invention signals the beginning of a code series that will identify the associated pipeline segment.

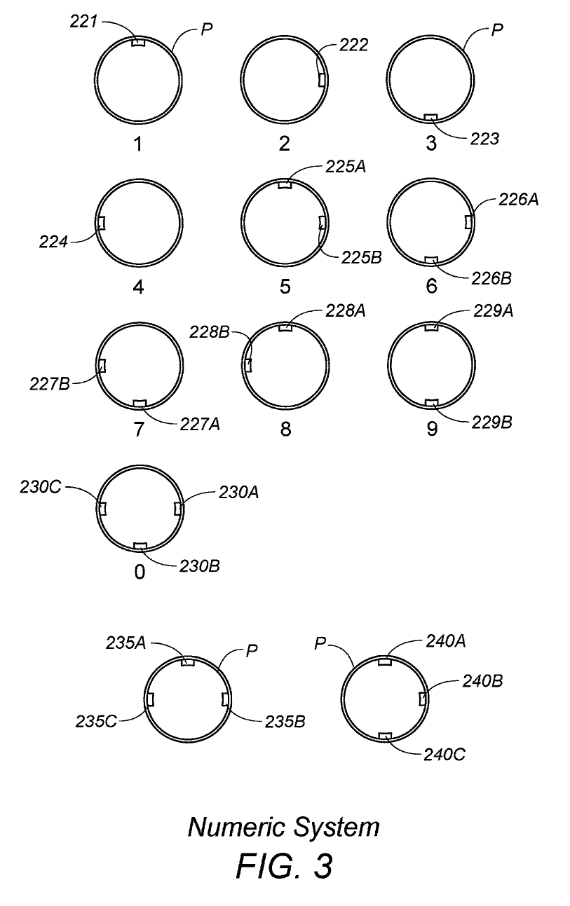

Now referring to FIG. 3, there is depicted a pluratity of markers that are separated by 90° and that correspond to codes for using the decimal system to represent pipeline locations. Thus, the number “1” is represented by coupon 221 that is seen disposed at the 12 o'clock position of pipeline segment P. The number “2” is represented by coupon 222 that is seen disposed at the 3 o'clock position of pipeline segment P; the number “3” is represented by coupon 223 that is seen disposed at 6 o'clock; and, the number “4” is represented by coupon 224 that is seen disposed at 9 o'clock. Similarly, the number “5” is represented by pair of coupons 225 A and B disposed at 12 o'clock and 3 o'clock, respectively. The number “6” is represented by pair of coupons 226 A and B disposed at 3 o'clock and 6 o'clock, respectively; number “7” is represented by coupon doublet 227 A and B disposed at 6 o'clock and 9 o'clock, respectively; number “8” is represented by coupon doublet 228 A and B disposed at 9 o'clock and 12 o'clock, respectively; and, number “9” is represented by pair of coupons 229 A and B disposed at 12 o'clock and 6 o'clock, respectively. Number zero is shown as being represented by coupon triplet 230 A, B, C disposed at the 3 o'clock, 6 o'clock, and 9 o'clock positions, respectively, of pipeline segment P.

Still referring to FIG. 3, it should be clear that the Registration Mark of the present invention simultaneously signifying the pipeline segment's top position and the beginning of the code series is represented by coupon triplet 235 A, B, C disposed at 12 o'clock, 3 o'clock, and 9 o'clock positions, respectively. It will also be understood that it has been found to be advantageous to have a corresponding Registration Mark signifying the end of a pipeline location code series. Accordingly, this end-of-code Registration Mark is represented by coupon triplet 240 A, B, C disposed at 12 o'clock, 3 o'clock, and 6 o'clock, respectively. In a similar fashion to the beginning code Registration Mark flagging the pipeline segment's top position, the code terminating Registration Mark flags the pipeline segment's 3 o'clock position. This feature, of course, is attributable to related coupons 240 A and C constituting delimiting means for the related medial location of coupon 240 B disposed at 3 o'clock. Similarly, coupons 235 B and C delimit the 12 o'clock Location of coupon 235 A, thereby flagging the beginning code Registration Mark.

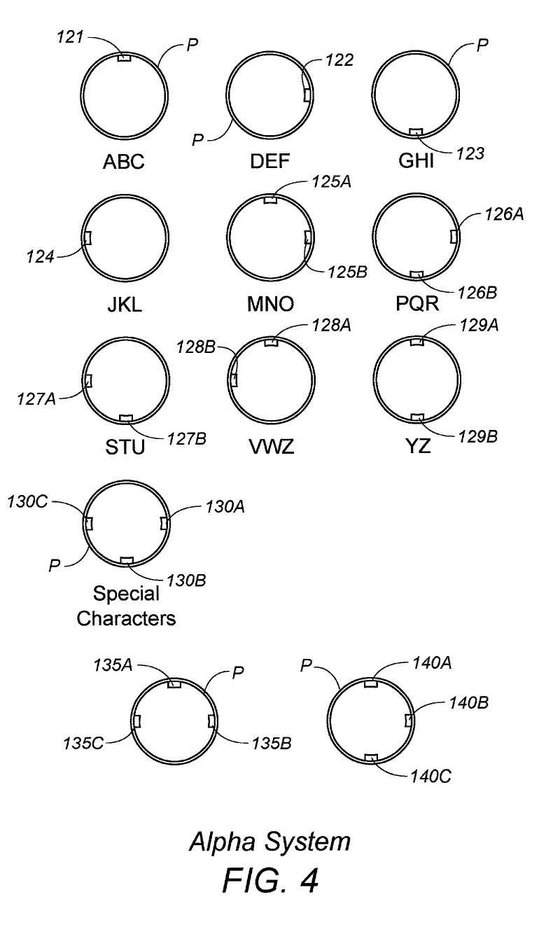

It should be evident that other combinations of a plurality of marker coupons may be used to represent letters, special characters, or the like. For instance, FIG. 4 shows the use of a plurality of coupons to represent alphabetical characters. There is depicted a plurality of markers that are separated by 90° and that correspond to codes for using predefined alphabetic codes to represent pipeline locations. Thus, the alphabetic code “ABC” is represented by coupon 121 that is seen disposed at the 12 o'clock position of pipeline segment P. The alphabetic code “DEF” is represented by coupon 122 that is seen disposed at the 3 o'clock position of pipeline segment P; the alphabetic code “GHI” is represented by coupon 123 that is seen disposed at 6 o'clock; and, the alphabetic code “JKL” is represented by coupon 124 that is seen disposed at 9 o'clock. Similarly, the alphabetic code “MNO” is represented by pair of coupons 125 A and B disposed at 12 o'clock and 3 o'clock, respectively. The alphabetic code “PQR” is represented by pair of coupons 126 A and B disposed at 3 o'clock and 6 o'clock, respectively; alphabetic code “STU” is represented by coupon doublet 127 A and B disposed at 6 o'clock and 9 o'clock, respectively; alphabetic code “VWX” is represented by coupon doublet 128 A and B disposed at 9 o'clock and 12 o'clock, respectively; and, alphabetic code “YZ” is represented by pair of coupons 129 A and B disposed at 12 o'clock and 6 o'clock, respectively. A generic special character is shown as being represented by coupon triplet 130 A, B, C disposed at the 3 o'clock, 6 o'clock, and 9 o'clock positions, respectively, of pipeline segment P.

Still referring to FIG. 4, it should be clear that the Registration Mark of the present invention simultaneously signifying the pipeline segment's top position and the beginning of the code series is represented by coupon triplet 135 A, B, C disposed at 12 o'clock, 3 o'clock, and 9 o'clock positions, respectively. It will also be understood that it has been found to be advantageous to have a corresponding Registration Mark signifying the end of a pipeline location code series. Accordingly, this end-of-code Registration Mark is represented by coupon triplet 140 A, B, C disposed at 12 o'clock, 3 o'clock, and 6 o'clock, respectively. In a similar fashion to the beginning code Registration Mark flagging the pipeline segment's top position, the code terminating Registration Mark flags the pipeline segment's 3 o'clock position. This feature, of course, is attributable to related coupons 140 A and C constituting delimiting means for the related medial location of coupon 140 B disposed at 3 o'clock. Similarly, coupons 135 B and C delimit the 12 o'clock location of coupon 135 A, thereby flagging the beginning code Registration Mark.

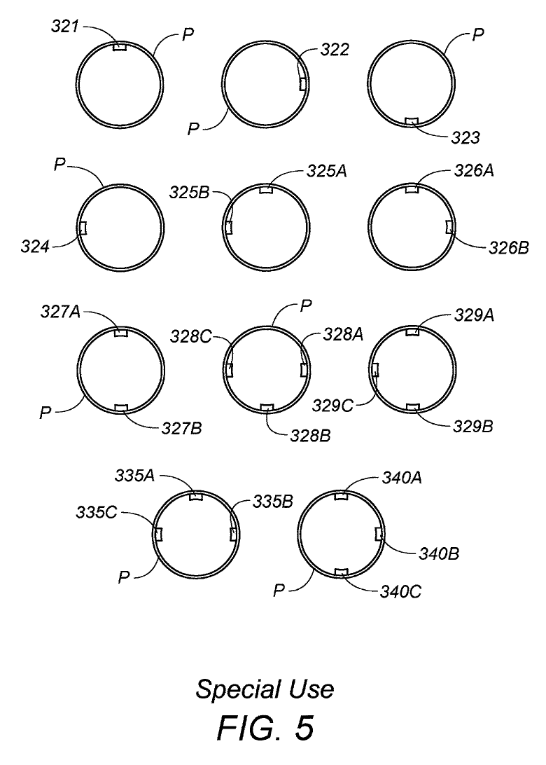

Now referring to FIG. 5 there is seen the use of a plurality of coupons to represent geographical landmarks and locations. There is depicted a plurality of markers that are separated by 90° and that correspond to codes for using predefined alphabetic codes to represent pipeline locations. Thus, the landmark code “North Bend-Up” is represented by coupon 321 that is seen disposed at the 12 o'clock position of pipeline segment P. The landmark code “East Bend-Right” is represented by coupon 322 that is seen disposed at the 3 o'clock position of pipeline segment P; the landmark code “South Bend-Down” is represented by coupon 323 that is seen disposed at 6 o'clock; and, the landmark code “West Bend-Left” is represented by coupon 324 that is seen disposed at 9 o'clock. Similarly, the landmark code “Pipeline/Cable Left/West” is represented by pair of coupons 325 A and B disposed at 12 o'clock and 9 o'clock, respectively. The landmark code “Pipeline/Cable East/Right” is represented by pair of coupons 326 A and B disposed at 12 o'clock and 3 o'clock, respectively; landmark code “Pipeline/Cable Above/Below” is represented by coupon doublet 327 A and B disposed at 12 o'clock and 6 o'clock, respectively; landmark code “Pipeline Corridor Multiple Pipelines” is represented by coupon triplet 328 A, B, C disposed at the 3 o'clock, 6 o'clock, and 9 o'clock positions, respectively, of pipeline segment P. Similarly, landmark code “Begin Casing River Crossing” is represented by coupon triplet 329 A, B, C disposed at the 6 o'clock, 9 o'clock, and 12 o'clock positions, respectively. Still referring to FIG. 5, it should be clear that the Registration Mark of the present invention simultaneously signifying the pipeline segment's top position and the beginning of the code series is represented by coupon triplet 335 A, B, C disposed at 12 o'clock, 3 o'clock, and 9 o'clock positions, respectively. It will also be understood that it has been found to be advantageous to have a corresponding Registration Mark signifying the end of a pipeline location code series. Accordingly, this end-of-code Registration Mark is represented by coupon triplet 340 A, B, C disposed at 12 o'clock, 3 o'clock, and 6 o'clock, respectively. In a similar fashion to the beginning code Registration Mark flagging the pipeline segment's top position, the code terminating Registration Mark flags the pipeline segment's 3 o'clock position. This feature, of course, is attributable to related coupons 340 A and C constituting delimiting means for the related medial location of coupon 340 B disposed at 3 o'clock. Similarly, coupons 335 B and C delimit the 12 o'clock location of coupon 335 A, thereby flagging the beginning code Registration Mark.

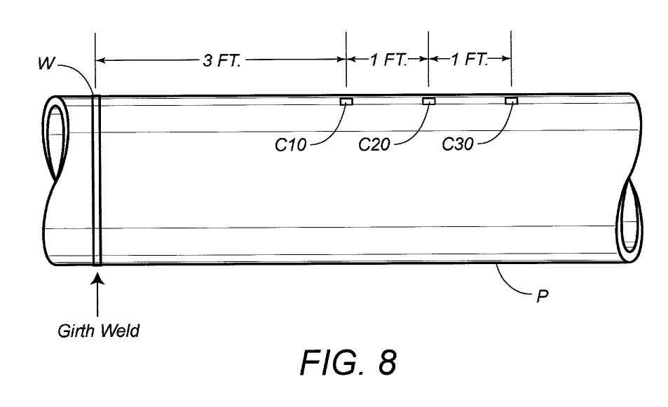

It will be understood that spacing of markers is important for assuring a readable code. Thus, markers are only placed in the top, right, bottom, and left sides to sustain code-legibility for low-resolution smart pigs. It will be appreciated by those skilled in the art that installation of the code structure taught by the present invention should preferably provide sufficient space between marker coupons. For example, it has been found that, when installing the character zero—requiring markers in all four positions—the plurality of markers should preferably be separated by a space equal to or greater than the width of an individual marker, in order to achieve the readability objectives of the present invention. Referring to FIG. 8, there is shown a simplified sketch of pipeline P having plurality of coupons C10, C20, C30, etc. as appropriate to properly represent the PIPS code as contemplated by the present invention. Relative to weld W, first coupon C10 is disposed on the internal diameter of pipeline segment P at about 3 feet from weld W to represent the first alphanumeric character. It has been found advantageous to install successive coupon C20 on the internal diameter of pipeline segment P at about 1 foot from previously placed coupon C10. Successive coupon C30 should preferably be placed on the internal diameter of pipeline segment P at about 1 foot from previously placed coupon C20. Similarly, coupons successive to C30, etc., should preferably be placed on the internal diameter of pipeline segment P at about 1 foot from the corresponding immediately previously placed coupon. As hereinbefore described in detail, it is contemplated that the last alphanumeric character wilt be a terminating end-of-code Registration Mark.

As hereinbefore described, the first character in a PIPS installation is a Registration Mark flagging the beginning of the pipe section identification and location code. It will become obvious that this Registration Mark informs the operator that a code follows. The code is installed to follow the flow of the product traveling within the pipeline, and is read conventionally from left to right. If this flow were reversed, then the Registration Mark would be the last character on the graph, indicating that the installation was in the opposite direction. It will be appreciated that the code is read, for reversed pipeline flow, from right to left.

It will be noted that the Registration Marks of the present invention inherently identify the top position of the pipeline. This feature is useful for verifying the accuracy of the radial orientation provided by a smart pig or the like.

To implement the appropriate code for a pipeline segment, the next alphanumeric character is preferably emplaced in a circumference several inches apart from the beginning Registration Mark. It has been found to be preferable to sustain a separation between parallel lines of code at least twice the length of the individual marker coupons. For instance, areas that are marked with 2-inch square coupons should preferably have characters that are separated by 4 inches (2×2 in). As will become clear to those skilled in the art, such a sufficiently spaced installation of coupons should prevent crowding of signals that are recorded by smart pigs or the like.

Referring now to FIGS. 12 A and B, there is seen an alternative embodiment of the plurality of marker coupons of the present invention disposed at less than 90° spaced-apart clock positions. In particular, FIG. 12A depicts a simplified end view of a section of pipe showing a PIPS code implemented with marks that are disposed within the wall structure at less than 90° clock positions. Similarly, FIG. 12B depicts a simplified end view of a section of pipe showing the PIPS code implemented with marks that are disposed on the circumference at less than 90° spaced-apart positions. It should be evident that the thickness and frequency of such marker coupons would depend upon the pipe diameter and the like. It is contemplated that vital information about pipe manufacture such as manufacturer code, batch identification, material of composition, etc. Under the present invention, these markings would be tracked similar to the UPC code affixed to conventional goods. Scanning of these PIPS codes could be achieved by using special instrumentation, some of which may already be established as part of quality control procedures at the manufacturing site. This manufacturing data would be stored in a pipeline database to promote quality assurance and public safety and health. Quality and performance would be monitored during pipeline construction, maintenance, and decommissioning. Historical maintenance and accident-recovery data, of course, would be sustained in the database. It will be appreciated that a benefit of the present invention is that batches of pipe could be correlated with pipeline performance under a diversity of geographical and environmental scenarios. Obviously, batches of pipe would be correlated with their final destinations underground. Such knowledge would be profoundly useful to operators in the field for identifying potential problems that might be faced by other users of the same production run. Other pipeline owners of the same pipeline material could now share information related to performance of pipe on a batch-by-batch basis.

It will be readily appreciated by those skilled in the art that Registration Marks of the present invention may be used to identify and locate the beginning and end of specific sections of pipe. For example, areas that are not usually identified by smart pigs should be flagged with Registration Marks to avoid unnecessary excavations and to assign priorities in associated maintenance programs. Also, areas that have been repaired with composite material that tends not to be detected by smart pigs are flagged with Registration Marks to avoid excavating the same area. Obviously, this is an important aspect of the present invention because smart pigs will detect metal loss left by corrosion damage, but will not identify non-metallic sleeves. It will become clear that the present invention is also suitable for areas where light corrosion and damage to a pipeline's protective coating requires sandblasting and re-application of coating material.

It will be understood that in embodiments using externally-applied coupons, markers of identical size, shape, and wall thickness are applied externally to the pipe, either with glue, epoxy, welded, or fusion bonded to the pipeline wall, depending upon the nature and composition of the pipeline. On the other hand, in embodiments using internally-applied coupons, a thin material is preferably welded or glued to the pipeline's internal wall. To achieve coupon regularity, stencils are used to enable melted material to be applied, forming identical square marker coupons. In structural embodiments, pipeline material is typically removed by light grinding-internally or externally-producing the prerequisite plurality of code marks as localized loss of wall thickness.

It will be understood by those skilled in the art that recent developments in technology allow molecular level changes in material composites to consequently produce localized variations of metal structure. This, of course, would be a particularly advantageous factory-application of PIPS, wherein manufactured pipe is marked to identify its source of origin, batch, etc. It will be appreciated by those skilled in the art that structural changes to the pipeline thickness may also be achieved by appropriately changing the density of the material in different 90° positions or the like produces the same code that would be obtained by attaching material to the pipe. It will be understood that this approach functions like X-ray images of metal samples, detecting different densities of material.

Those skilled in the art will appreciate the following illustrative application of the present invention. According to typical maintenance programs in the art, a pipeline requires smart pig inspections on a yearly basis. Instead of assessing a budget for funding annual installation of conventional temporary markers, a pipeline owner now installs appropriate PIPS codes the first year. Under the preferred embodiment, such PIPS codes are applied at one-mile intervals on a 100 mile long, 12 inch diameter steel pipeline, with 0.250″ wall thickness. Each location is accorded a Registration Mark to signal the beginning of code and the marker coupons for each digit. As hereinbefore described, marker coupons are sized so that up to four marker coupons may be applied to the circumference without touching each other, preferably leaving a few inches therebetween. It has been found that this configuration allows for detection by smart pigs or the like, with low resolution. Hence, markers of proper size can be detected by MFL or ultrasonic pigs that carry low resolution sensors. It will be appreciated that the minimum resolution comfortably allows for 3″ square marker coupons.

It should be evident that such square coupons should preferably be cut from pipe or steel of the same thickness as the underlying pipeline (0.250″). Each Registration Mark should be placed about one foot away from the girth weld joint, and the mile number should be placed about 6 inches from the Registration Mark. Successive digits should preferably be placed about 6 inches away from the previous mark. For simplicity, all marker coupons for each location should be placed on belts as long as the circumference of the pipe. The belts are labeled with mile number, top position, and order of placement. Then, crew workers weld, braze, or glue the plurality of individual marker coupons to the pipeline in a manner well known in the art.

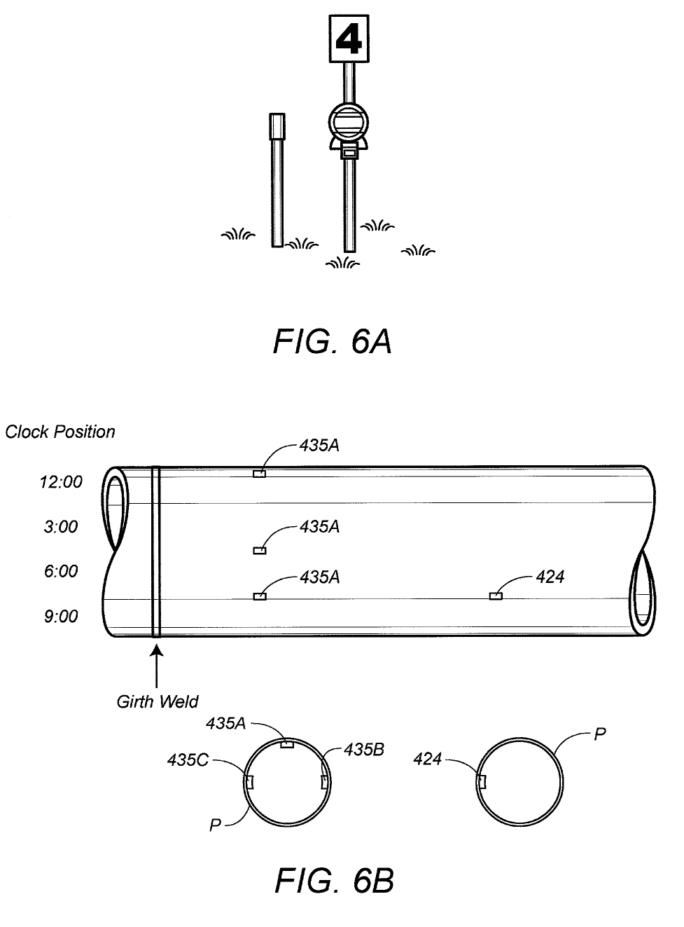

As an example, FIGS. 6A and B depict the application of the present invention to a conventional pipeline marker for “Mile Post 4.” FIG. 6A depicts Mile Post 4, typically referred to as “MP4” in the field. FIG. 6B depicts the clock position of each of marker coupons 435 A, B, C and 424 corresponding to PIPS beginning-of-code and code “4.” It will be clear that the beginning-of-code Registration Mark signals the operator that a plurality of identification and location codes will follow; it also signals the top position of the pipeline segment for smart pig calibration purposes or the like. Coupon 424 representing code of “4” disposed at the 9 o'clock position corresponds to MP4.

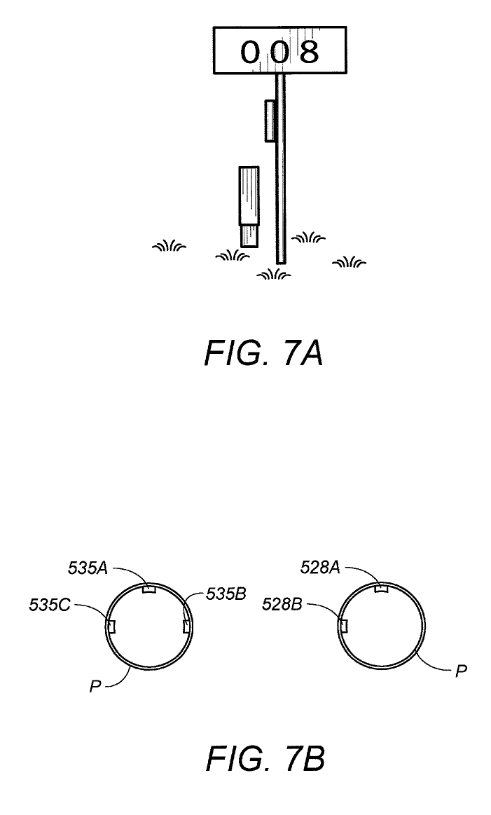

As another example, FIGS. 7A and B depict the application of the present invention to a conventional pipeline marker for “Mile Post =b 8.=l ” FIG. 7A depicts Mile Post 8, typically referred to as “MP8” in the field. It will be understood that internal inspection devices fail to recognize such pipeline sites as shown in FIGS. 6A and 7A unless specific markers are placed during a survey or the like. The particular geographic location is then correlated with the distance traveled by the inspection device to property locate and label the site in the inspection report. FIG. 7B depicts the clock position of each of plurality of marker coupons 535 A, B, C and 528 A, B corresponding to PIPS beginning-of-code and code “8”. It will be clear that the beginning-of-code Registration Mark signals the operator that a plurality of identification and Location codes wilt follow; it also signals the top position of the pipeline segment for smart pig calibration purposes or the like. Coupons 528 A and B representing code of “8” disposed at the 9 and 12 o'clock positions correspond to MP8. It should be evident that, even if a smart pig fails to accurately record distance during pipeline inspection, the in situ PIPS marker will still accurately and reliably record the position of aerial marker MP8. The present invention contemplates that no other geographical location of the pipeline will be accorded the same identifying name or code.

It will be evident to those skilled in the art that the present invention affords a panoply of important advantages for the pipeline identification and positioning art. A pipeline owner may develop a unique protected code in order to identify the pipeline or sections of pipeline that are of special interest. No special training or background is required for the code-installation. It should be clear that on-site preparation and easy-to-follow code-application are a feature of the present invention.

Location of PIPS pipeline markers need not to be disclosed to any third party when performing a survey. Smart pigs can detect all PIPS-marked locations while no interpretation of the code is given to the inspection company. It should be evident that PIPS promotes the identification of problems during inspections, and before inspection equipment Leaves the job-site. The precise accuracy of the system of the present invention verifies linear distance measurements performed by smart pigs. Orientation of PIPS markers promotes verification of the clock position of the pig sensors.

Unlike the prior art, failure of smart pig odometer readings do not jeopardize the identification of PIPS markers. It will be appreciated that smart pig problems are easily identified when PIPS markers appear in the wrong position. Exact distances between PIPS markers that do not correlate to smart pig measurements identify problems before the inspection crews leave the job-site. All PIPS markers for a specific pipeline should preferably be of similar size and characteristics, and installed with a uniform criteria. Then, smart pigs that record markers as having different sizes, thickness, or features may point to sensor malfunctions. It will also be appreciated that the installation cost of a PIPS marker, being inherently permanent and maintenance-free, is significantly lower than the cost associated with traditional inspection methods. Future surveys do not require additional investments such as new magnets, coils or electronic systems. Unlike purported positioning methodologies heretofore known, PIPS is not susceptible to losses, vandalism, breakage, radio interference, signal interruption, false readouts, etc. Furthermore, no physical evidence above-ground is necessary to locate the same spot repeatedly over the life of the pipeline. PIPS system is vendor-independent, regardless of the detection technology used or the provider of such technology. Obviously, failure to record a PIPS marker points to problems with the inspection pig.

It should be evident to those skilled in the art that pipelines that transport virtually any type of product, including oil, natural gas, water, or any other similar material, may be marked as contemplated by the present invention. PIPS marks will be readily detected and identified by inspection with smart pigs or other common instruments or the like that detect changes in the thickness or composition of the steel or plastic material constituting the pipe wall or the like. Ultrasonic equipment used to inspect polyethylene or polypropylene pipe will also detect PIPS markings. It should also be clear that the benefits of being able to locate every piece of defective pipe anywhere far outweigh the modest installation cost. Pipe factory installation of the markings of the present invention could include such source-of origin information as the pipe manufacturer plant ID, batch, and the like. Similarly, installation in the field could indicate the presence of physical landmarks such as pipeline crossings or distances of pipelines to railroad crossings and bridges.

Many pipelines are identified with aerial markers that are typically visually verified from small plane surveys. These markers are not normally attached to the pipeline and are not recorded by the inspection instruments. Placement of PIPS marks on the pipe readily identify the mile post and provide clear correlation between above-ground references and PIPS markings on the buried pipe.

Similarly, in urban areas, PIPS code markings on pipelines traversing neighborhoods would help to minimize damage to private property when excavating pipelines during maintenance. Accurate above-ground satellite readings of the position of the PIPS markings would bring crews to within an inch of the exact position of the underlying pipeline. Additional PIPS markings on the pipeline could record distance to high voltage, optic, or other cables thereby avoiding accidents and expensive disruptions of service. Pipelines entering private property and having PIPS code would mark the boundaries of private property affected by the pipeline right of way. Of course, any defect detected by inspection instruments would promptly be located with minimum disruption of neighborhoods. Pipelines with PIPS markings near school zones, hospitals, and other public buildings would be quickly identified as areas of risk. Pipeline defects would be readily detected near urban areas and school zones. It will be appreciated by those skilled in the art that the above-ground markers such as posts are not normally marked on the pipeline. Unfortunately, a hazardous defect near a risk area would appear just as one in any other section of the pipeline. On the other hand, PIPS markings would help prioritize repair activities by managing risk.

Posts commonly seen in the public eye draw attention to railroad crossings. near a bridge at a busy intersection. Some railroad crossings, unfortunately, are not only situated near a bridge or the Like, but also implicate congested intersections. Such locations are typically identified with yellow posts to indicate the presence of a pipeline below. PIPS markings installed on the pipeline detected by inspection instruments would accurately define the beginning and end of the intersection, railroad crossing, and the highway nearby. The location of any potentially dangerous defect would be quickly assessed and prompt measures taken.

In commercial urban areas, pipelines crossing neighborhoods, especially in corridors of multiple pipelines could be advantageously marked with PIPS code. Not only could the number of pipelines in the corridor be recorded, but also the nature of the product being transported and the distance to the nearest pipeline. Pipeline crossings could have each pipeline marked with PIPS code indicating the distance to other pipelines installed below, above, or in proximity thereto. PIPS markings could provide additional details for a bend area. New neighborhoods or commercial developments in the area could be recorded on the PIPS pipe code. Even cathodic protection systems that protect pipelines from corrosion and that include rectifiers for impressing current upon the pipeline could be marked with PIPS code during maintenance to the rectifier connections to the pipeline.

Another benefit of the present invention pertains to national security. The location of buried pipelines on government property need not be disclosed to inspection companies. Indeed, the government agency responsible for the pipeline can develop its own PIPS code and then mark pipelines. It will be understood that the information recorded by smart pigs or another inspection instrument does not reveal any information to the inspection crews. Thus, pipelines in remote locations that are subject to terrorist attacks could be marked in situ without disclosing any information above-ground. Inspections with smart pigs would not require placing benchmarks on the ground for distance referencing.

Many other means of public transportation are required to carry special licenses, as well as information regarding weight, capacity, and other data. Information required by federal or state regulatory agencies could be recorded with PIPS code on the pipeline, providing information electronically after smart pig surveys or the like.

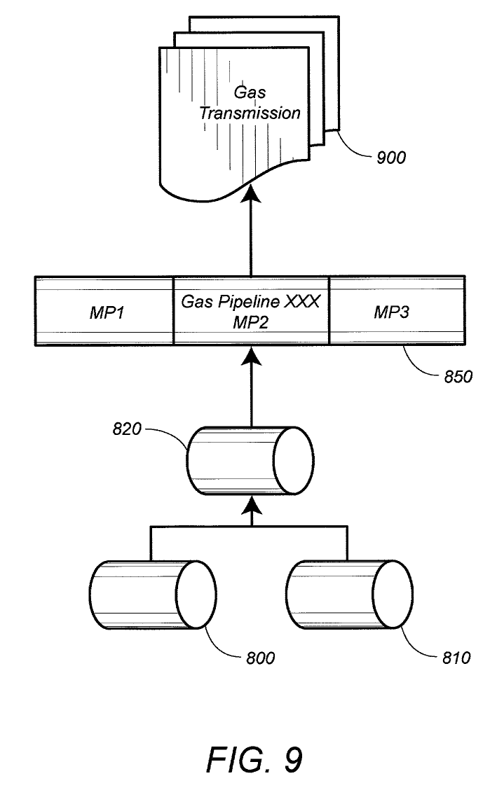

It is within the contemplation of the present invention to accumulate the pipeline identification and positioning information stored in a plethora of in situ PIPS codes on a worldwide basis. Obviously, access to such a knowledge database can not only assure that pipeline maintenance is economically effectuated, but also can, among other things, help provide pipeline safety and even national security. FIG. 9 depicts a data flow diagram illustrating the database of the present invention. More particularly, there is shown PIPS database 900 having an accumulation of pipeline identification and positioning information stored in plurality of records 850. Each such record corresponds to a sequence of positioning information for a pipeline segment, e.g., MP1, MP2, MP3, etc. In a manner known in the art, included in this database may be PIPS codes corresponding to split pipeline sections 820 that, in turn, correspond to either unchanged PIPS codes for the section 800, or new or changed PIPS codes 810.

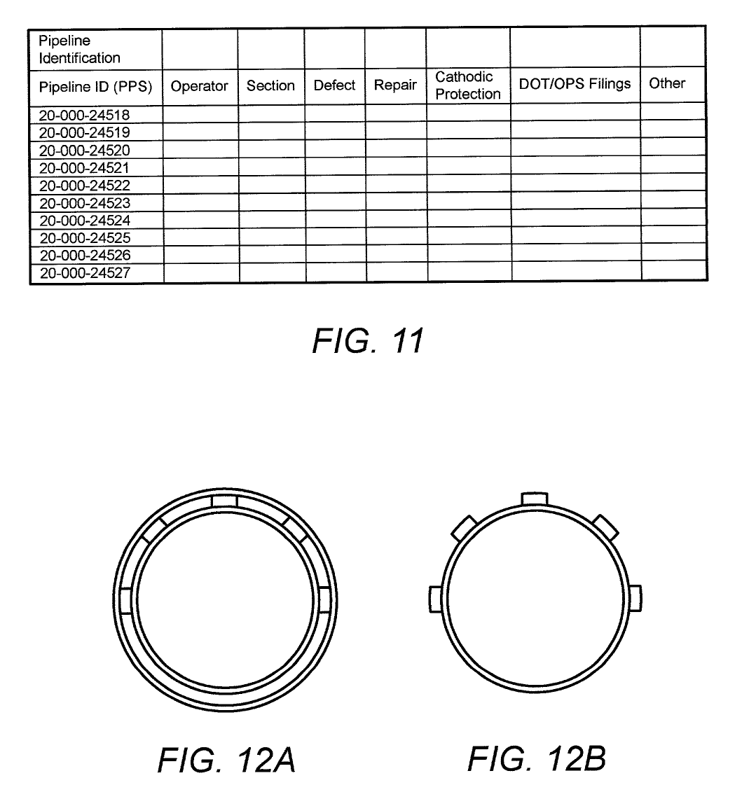

The sample tabulation shown in FIG. 11 depicts pipeline information that would be compiled by PIPS and be available for retrieval by authorized personnel and agencies, or the like. For each uniquely identified pipeline segment, corresponding to a row in the table, it should be obvious that a panoply of manufacturing, positioning, maintenance history, accident, etc., information may be stored. Thus, columns therein correspond to the operator, section of the pipeline, defect, repair, cathodic protection, and even DOT/OPS Filings. Of course any information relevant to pipelines may be stored.

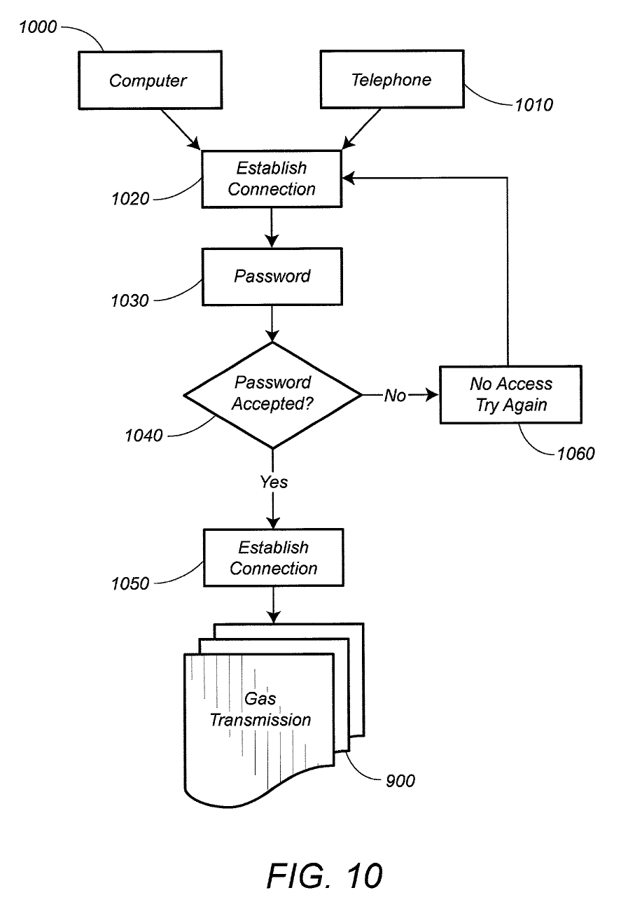

FIG. 10 depicts a simplified system flow diagram for remote access to PIPS database 900 depicted in FIG. 9. While performing pipelaying or pipeline maintenance, operators will have remote access to database 900. Remote access may be accomplished by voice communication via telephone or cellular phone 1010 or by data via computerized access to the Internet or private extranet or intranet 1000. In a manner well known in the art, a connection is first established 1020 and authorization via password or the like 1030 must be obtained. Legitimacy of this attempted remote access is tested 1040, with a pass-through 1050 granting access to database 900. If authorization or authentication is not obtained, 1060, then another attempt to establish a connection should be attempted 1020.

It is contemplated that the PIPS database would preferably keep track of a diversity of pipelines and concomitant performance and longevity information under a diversity of environments and operating conditions. Information accumulated by pipeline owners through smart pig inspection and the like could be shared expeditiously among practitioners in the art, thereby resulting in more reliable pipeline performance, increased public safety, and reduced operating costs. It is also contemplated that government and industrial agencies would monitor such databases on an appropriate level of detail to safeguard the public and national interest.

Other variations and modifications will, of course, become apparent from a consideration of the structures and techniques hereinbefore described and depicted. Accordingly, it should be clearly understood that the present invention is not intended to be limited by the particular features and structures hereinbefore described and depicted in the accompanying drawings, but that the present invention is to be measured by the scope of the appended claims herein.

What is claimed is:

1. For a pipeline having a plurality of contiguous pipeline segments with a watt and corresponding internal and external circumferential surfaces disposed transversely of said pipeline, a system for identifying and positioning each of said plurality of pipeline segments, said system comprising:
a first plurality of spaced-apart marker coupons affixed to said wall disposed in a band therealong;
a medial plurality of spaced-apart marker coupons affixed to said wall disposed in a band therealong and disposed parallel to said a first plurality of spaced-apart marker coupons, and parallel to each other of said medial plurality of spaced-apart marker coupons;
a last plurality of spaced-apart marker coupons affixed to said wall disposed in a band therealong and disposed parallel to said a first plurality of spaced-apart marker coupons and remotely thereof, with said medial plurality of spaced-apart marker coupons interposed between said first plurality of spaced-apart marker coupons and said last plurality of spaced-apart marker coupons; and
each of said spaced-apart marker coupons having an alphanumeric code contained thereon adapted to be detected by conventional pipeline detection methods.

2. The system recited in claim 1, wherein each said plurality of spaced-apart marker coupons is affixed to said internal circumferential surface of said pipe wall.

3. The system recited in claim 1, wherein each said plurality of spaced-apart marker coupons are affixed to said external circumferential surface of said pipe wall.

4. The system recited in claim 1, wherein each said plurality of spaced-apart marker coupons are incorporated into the internal structure of said pipe wall.

5. The system recited in claim 1, wherein a combination of said first plurality of spaced-apart marker coupons, said medial plurality of spaced-apart marker coupons, and said final plurality of spaced-apart marker coupons uniquely identify the manufacture of said pipeline segment.

6. The system recited in claim 1, wherein a combination of said first plurality of spaced-apart marker coupons, said medial plurality of spaced-apart marker coupons, and said final plurality of spaced-apart marker coupons uniquely identify the geographical location of said pipeline segment.

7. The system recited in claim 1, wherein said first plurality of spaced-apart marker coupons corresponds to a predefined configuration of said alphanumeric codes representing a beginning code Registration Mark.

8. The system recited in claim 7, wherein said beginning code Registration Mark is adapted to identify the top 12 o'clock position of said pipeline segment.

9. The system recited in claim 1, wherein said last plurality of spaced-apart marker coupons corresponds to a predefined configuration of said alphanumeric codes representing an ending code Registration Mark.

10. The system recited in claim 9, wherein said ending code Registration Mark is adapted to identify the 3 o'clock position of said pipeline segment.

11. The system recited in claim 1, wherein said plurality of spaced-apart marker coupons are emplaced in successive 90° positions of said pipe wall, corresponding to 12 o'clock, 3 o'clock, 6 o'clock, and 9 o'clock positions, respectively.
